(19) United States
(12) Patent Application Publication
(10) Pub. No.: US 2020/0074306 A1
(43) Pub. Date: Mar. 5, 2020

(54) FEATURE SUBSET EVOLUTION BY RANDOM DECISION FOREST ACCURACY

(71) Applicant: CA, Inc., New York, NY (US)

(72) Inventors: Erhan Giral, Saratoga, CA (US); Thomas Patrick Kennedy, East Northport, NY (US); Mark Jacob Addleman, Oakland, CA (US); Nathan Allan Isley, Corte Madera, CA (US); Michael J. Cohen, Flushing, NY (US)

(21) Appl. No.: 16/119,808

(22) Filed: Aug. 31, 2018

(51) Int. Cl. G06N 3/12

(52) U.S. Cl. CPC G06N 3/126

(57) ABSTRACT

A genetic algorithm (GA) in combination with a random decision forest can be used to identify a feature subset related to an observed incident. The GA is used to select feature subsets for which data samples are obtained to train and test random decision forests per individual feature subset (“individual”) with respect to an observed incident. For each generation of a GA run, fitness values of the individuals are determined based on the testing of the corresponding random decision forest. At termination of the GA run, an individual representing a feature subset is identified as likely most related to the observed incident. The trained random decision forest corresponding to the individual or a subset of the trained random decision forest is used to predict or classify whether live values of the fittest feature subset indicate the observed incident.

### BACKGROUND

The disclosure generally relates to the field of data processing, and more particularly to artificial intelligence.

Evolutionary Programming is term that was coined to encompass computational strategies that employ any data representation, any variation operators, and any selection procedure. Evolutionary programming includes genetic algorithms. A genetic algorithm (“GA”) is a generalized, computational strategy that is based on R. A. Fisher's formulation of mathematical genetics specifying a rate at which genes would spread through a population. The GA generalizations relate to interaction of genes on a chromosome rather than independent allele activity and to a larger set of genetic operators that include crossover and mutation. A GA is used to find a good or optimal solution to a problem by “searching” a solution space that is typically very large. A GA starts with a population of individuals that each represent a possible or candidate solution to the problem within the solution space. The GA runs through multiple iterations (“generations”) until encountering a termination criterion. For each generation, the GA uses a fitness function to evaluate fitness of each member of the generation. The GA selects members based on fitness and applies one or more genetic operators to generate a next generation.

For a classification task, an ensemble of decision trees can be used (“random decision forest”). A random decision forest is a supervised classification learning algorithm that generates/results in a classification model. Instead of constructing a single decision tree, multiple decisions trees are constructed with each root node being created with some randomness, such as a random splitting threshold in each root node. After the forest of decision trees have been trained, an input is supplied to the forest to generate multiple outcome predictions or predicted classifications. Based on the predicted classifications, the forest outputs a single predicted classification for the input.

### BRIEF DESCRIPTION OF THE DRAWINGS

Embodiments of the disclosure may be better understood by referencing the accompanying drawings.

FIG. 1 is a conceptual diagram of dimensional reduction for metric subset identification for incident analysis using a genetic algorithm and random decision forests.

FIG. 2 is a conceptual diagram of metric subset based classification of live metric values as related to a previously observed incident or not.

FIG. 3 is a flowchart of example operations for identifying a metric subset related to an observed incident.

FIG. 4 is another flowchart of example operations for identifying a metric subset related to an observed incident.

FIG. 5 is a flowchart of example operations for generating an ensemble of decision trees for each metric subset.

FIG. 6 depicts an example computer system with a genetic algorithm and random decision forest based feature subset optimization search engine.

### DESCRIPTION

The description that follows includes example systems, methods, techniques, and program flows that embody embodiments of the disclosure. However, it is understood that this disclosure may be practiced without these specific details. In other instances, well-known instruction instances, protocols, structures and techniques have not been shown in detail in order not to obfuscate the description.

Overview

In order to identify meaningful subsets of metrics produced by monitoring systems, machine learning techniques can be applied with intelligent feature selection guided by topology. However, a vendor agnostic solution for monitoring application behavior (e.g., software as a service (SaaS) solution) likely does not have awareness of topology to guide feature selection. A genetic algorithm (GA) in combination with a random decision forest can be used to identify a manageable number of metrics (“feature subset”) as “markers” related to an observed incident. A system (e.g., distributed application) may have thousands of agents and instruments that generate millions of metric values for monitoring application behavior. The numerous agents and instruments correspond to hundreds of thousands to millions of metrics (e.g., processor utilization at each host, subroutine calls, latency of each connection, etc.). The GA is used to select feature subsets for which data samples are obtained to train and test random decision forests per individual feature subset (“individual”) with respect to an observed incident. For each generation of a GA run, fitness values of the individuals are determined based on the testing of the corresponding random decision forest. At termination of the GA run, a feature subset is identified as likely most relevant to the observed incident. In addition, a decision tree or ensemble of tree-based classifiers corresponding to the feature subset is used to predict or classify whether live values of the fittest feature subset indicate the observed incident.

### Example Illustrations

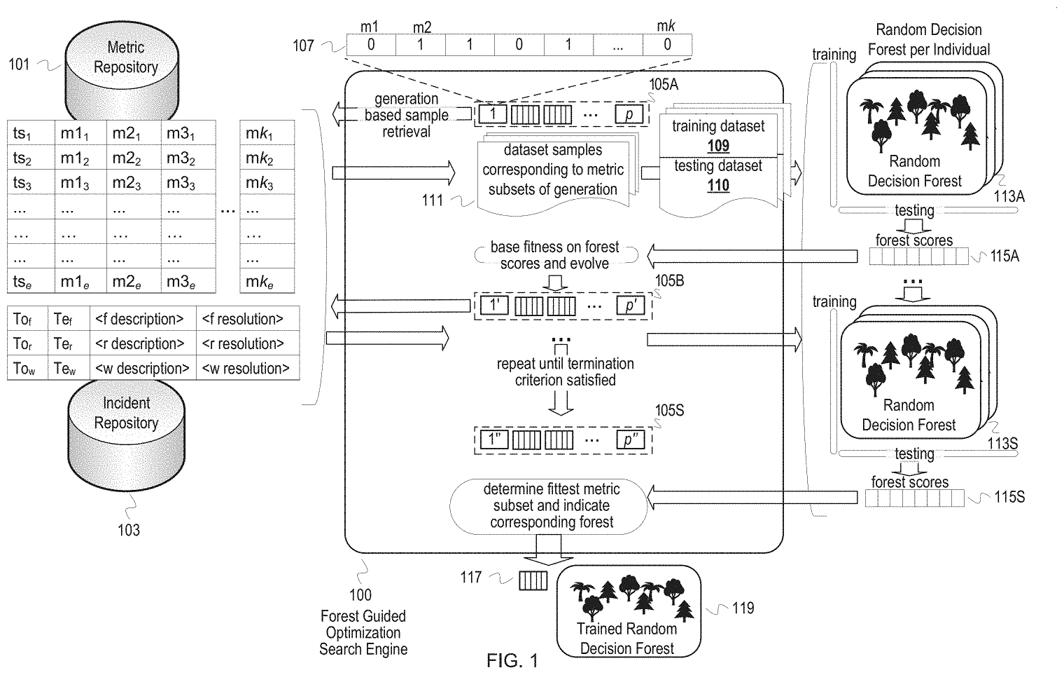

FIG. 1 is a conceptual diagram of dimensional reduction for metric subset identification for incident analysis using a genetic algorithm and random decision forests. A forest guided optimization search engine 100 runs an instance of a genetic algorithm until a termination criterion is met for evolving generations of feature subsets. The feature subsets are subsets of metrics of a system or application (“monitored metrics”). The forest guided optimization search engine 100 uses random decision forests to guide the evolution of individuals across generations.

Although values of monitored metrics can be recorded across multiple repositories (e.g., databases or stores), FIG. 1 depicts a single metric repository 101 to avoid complicating the figure. Each example entry of the metric repository 101 includes a timestamp (ts) and values for a set of metrics m₁-mₖ corresponding to the timestamp. This illustration simplifies the organization of metric values. More likely, an implementation does not organize the multitude of metric values into a table. For instance, a metric repository likely organizes metrics hierarchically since a component will have multiple metrics and those metrics can have child metrics. Furthermore, the agents/instruments communicating the various metric values are distributed across numerous components and likely communicate at different times and at different intervals. Thus, metric values likely do not align to a same time.

In addition to the metric repository 101, an incident repository 103 is leveraged. The incident repository 103 indicates incidents (e.g., alarms, events, etc.) that have been observed for the monitored system or application. In FIG. 1, entries in the incident repository 103 each include a timestamp when the incident was observed (Tₒ) and a timestamp when the incident was resolved (Tₑ). Each entry also includes a description and a resolution of the incident. FIG. 1 depicts entries for three incidents labeled f, r, and w. The labels can be specific incidents (e.g., insufficient memory at host 1) or types/classes of incidents (e.g., latency of a transaction).

The forest guided optimization search engine 100 identifies a feature subset most related to an observed incident and a corresponding random decision forest as a classifier for live metrics. The feature subset to be identified after termination of the genetic algorithm program will relate to an incident that has been previously observed and recorded into the incident repository 103. In addition, a decision tree or ensemble of tree-based classifiers corresponding to the feature subset will be generated to classify live metric values as either related to the previously observed incident or not. If a set of live metric values are classified as related to a previously observed incident, then root cause analysis can focus investigation on the metrics in the feature subset and/or reference can be made to a resolution action(s) or instructions for the previously observed incident.

Initially, an incident or class of incidents will be identified (“target incident”) to the forest guided optimization search engine 100 for the feature subset identification. The forest guided optimization search engine 100 can access the incident repository 103 to determine times or time boundaries corresponding to the target incident. A target incident may be associated with a single time or multiple times that are considered boundaries for the target incident. The time boundaries can be when an incident is detected and when it is resolved, although time boundaries are not limited to these times. For instance, a first time boundary for an incident can be a time prior to detection of the incident. This captures information leading up to the incident detection. The selected target incident will guide sampling of the data from the metric repository 101. Metric values collected, measured, or detected within a time range defined by the time boundaries of a target incident would be samples corresponding to the target incident. Based on the selected target incident, a set of potentially related metrics can be identified. This would reduce the universe of metrics to search for a metric set most related to the target incident by orders of magnitude, for example from hundreds of thousands of metrics to 50 metrics.

Based on this initial set of potentially related metrics (“candidate metric set”), the genetic algorithm instance generates an initial generation of feature vectors or individuals according to parameters specified for the genetic algorithm. The parameters define population size (p) in each generation (i.e., number of individuals in a generation), size of an individual (m) (i.e., number of metrics indicated in an individual), and one or more termination criteria. In some embodiments, the individual size parameter is not specified because it is based on the capacity of the data structure used for an individual. To generate each individual, the genetic algorithm instance randomly selects m metrics from the candidate metric set. Upon generating p individuals, an initial generation 105A is established. Some embodiments may scan and modify individuals to satisfy a predefined condition for an initial generation (e.g., threshold overlap among individuals). Furthermore, some embodiments may generate the initial population based on results of previous runs of the genetic algorithm. A property or flag can be set to indicate whether an execution or run of the GA should randomly generate the initial population or generate the initial population based on a previous result.

After establishing the initial generation 105A, the forest guided optimization search engine 100 retrieves generation-based dataset samples from the metric repository 101. Input or a configuration setting in a file can specify sample size. The forest guided optimization search engine 100 retrieves some dataset samples that relate to the target incident. Based on the times or time boundaries of the target incident, the forest guided optimization search engine 100 obtains metric values that relate to the target incident. The forest guided optimization search engine 100 also retrieves dataset samples that do not relate to the target incident. The forest guided optimization search engine 100 splits the retrieved samples into a training dataset and a testing dataset. For the individuals or metric subsets in the first generation, the forest guided optimization search engine 100 retrieves dataset samples 111. The dataset samples 111 include samples for each of the individuals in the first generation 105A. Due to constituent metric overlapping among individuals, some samples can be shared or copied across individual sample sets instead of accessing the repository 101 repeatedly for the same metric samples. For each of the individuals, the forest guided optimization search engine 100 splits the corresponding samples of the dataset samples 111 into a training dataset 109 and a testing dataset 110. Since the retrieved dataset samples 111 are historical metric values, the ones relating to incidents have been or can be labeled as related to the target incident.

For each individual of the generation 105A, the forest guided optimization search engine 100 generates a random decision forest 113A. The forest guided optimization search engine 100 generates a random decision forest 113A as constrained by the constituent metrics of a corresponding individual. Various techniques can be used to generate, grow, and prune the decision trees of a random decision forest. For instance, the decision trees can be generated based on information entropy and gain or determined mutual information among the considered metrics. The forest guided optimization search engine 100 trains the generated random decision forest of an individual in the generation 105A with the training dataset 109 of that individual. After training, the forest guided optimization search engine 100 tests the random decision forest with the corresponding testing dataset 110. Testing involves passing each slice of the testing dataset 110 (slice being the subset of metric values that correlate to a same or similar time) for an individual of a current generation into the trained random decision forest of the individual. The trained random decision forest predicts a label (related or not related to the observed incident) for each slice. The predicted labels or compared to the actual labels. An accuracy score is computed for the random decision forest based on the comparison of predicted labels to actual labels. This results in a set of forest scores 115A that represent classification accuracy of the random decision forests 113A. The program code/instructions (subroutine(s)) executed to perform individual fitness evaluation in a GA are referred to as a fitness function. The forest guided optimization search engine 100 uses a fitness function that encompasses the training and testing of a random decision forest for an individual to obtain a forest score, which is used as a basis for the fitness value. The fitness function is run per individual. Execution of the fitness function is independent across individuals. Thus, the fitness function can be executed asynchronously and concurrently for each individual.

The forest guided optimization search engine 100 then uses the forest scores 115A to evaluate fitness of the individuals of the generation 105A and evolve to a next generation 105B. The forest scores 115A can be used directly as fitness values for the individuals of the generation 105A or can be adjusted. The forest guided optimization search engine 100 applies one or more genetic operations on the generation 105A based on the fitness values, such as crossover.

The forest guided optimization search engine 100 repeats this process of training and testing random decision forests generated for each generation and using the forest scores to evolve to a next generation. When a termination criterion for the GA instance is satisfied, the GA instance yields a final generation 105S of individuals. The forest guided optimization search engine 100 generates random decision forests 113S based on the generation 105S. After training and testing the random decision forests 113S, testing yields forest scores 115S. The forest guided optimization search engine 100 uses these forest scores 115S to evaluate fitness of the last generation 105S. Based on the fitness values of the individuals in the generate 105S, the forest guided optimization search engine 100 determines a subset of metrics 117 based on the fittest individual(s) in the generation 105S. The forest guided optimization search engine 100 also determines a trained random decision forest 119 that is based on the subset of metrics 117. The forest guided optimization search engine 100 communicates or provides the metric subset 117 as the metrics most related to the target incident for root cause analysis and/or resolution when the trained random decision forest 119 classifies a set of live metric values as related to the target incident (i.e., indicating that the target incident has likely occurred or will likely occur).

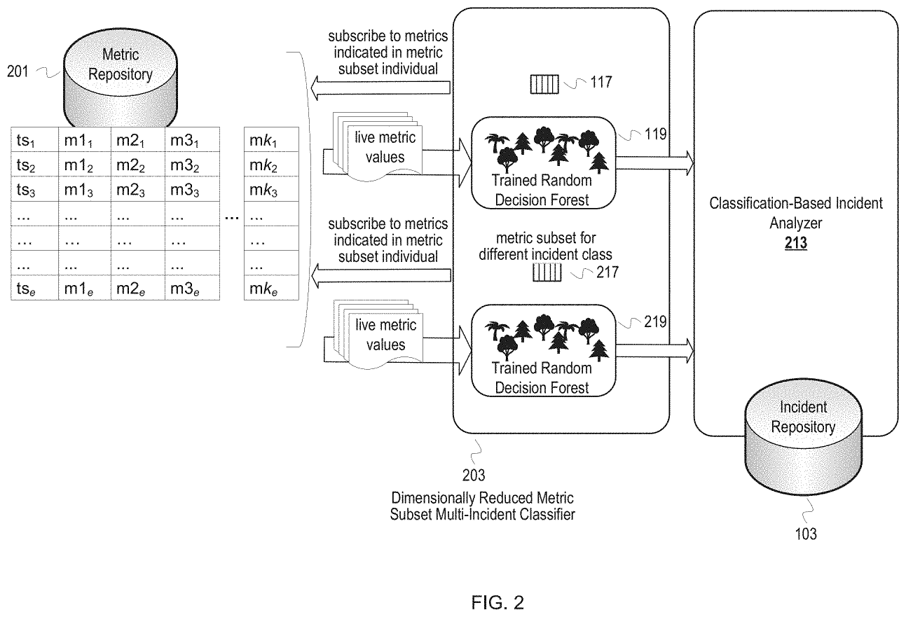

FIG. 2 is a conceptual diagram of metric subset based classification of live metric values as related to a previously observed incident or not. In FIG. 2, the previously identified metric subset or individual 117 and corresponding trained random decision forest 119 has been deployed as part of a dimensionally reduced metric subset multi-incident classifier 203. In addition, a metric subset 217 and a corresponding trained random decision forest 219 has also been deployed as part of the dimensionally reduced metric subset multi-incident classifier 203. The metric subset 217 and the trained random decision forest 219 have been generated based on the process described in FIG. 1 for a different target incident. The dimensionally reduced metric subset multi-incident classifier 203 can be a program that encompasses both metric subsets 117, 217 and forests 119, 219. Alternatively, each trained random decision forest 119, 219 and corresponding program code to invoke the forest may be a standalone program or subroutine, or run within a container (e.g., virtual machine).

Streams of live metric values for the metric subsets are fed through the classifiers for different incidents. A thread or process of the trained random decision forest 119 subscribes to metrics in a metric repository 201 based on the metrics indicated in the metric subset 117. A thread or process of the trained random decision forest 219 subscribes to metrics in a metric repository 201 based on the metrics indicated in the metric subset 217. A subscription paradigm is not necessary. The thread or process can periodically retrieve values from the metric repository 201 or be event driven. For instance, the thread/process/daemon for a trained random decision forest can read metric values of the particular metrics based on a manual event or detection of preset conditions for the application or system. The random decision forest 119 evaluates time slices of the live metric values (i.e., metric values being collected for an active system/application) corresponding to the metrics of the metric subset 117. Similarly, the random decision forest 219 evaluates time slices of the live metric values corresponding to the metrics of the metric subset 217. If a time slice of live metric values is classified or predicted by the trained random decision forest 119 as related to an incident class for which the forest 119 was trained, then a notification is sent to a classification-based incident analyzer 213. Likewise, a notification is communicated to the analyzer 213 if the trained random decision forest 219 classifies or predicts a time slice of live metric values as related to an incident class for which the forest 219 was trained.

The analyzer 213 can be variously programmed to utilize the information from the dimensionally reduced metric subset multi-incident classifier 203. A notification from the classifier 203 may identify the related incident. The analyzer 213 can access the incident repository 103 based on the related incident identifier and retrieve at least one of the description and the resolution for the incident. The analyzer 213 can then communicate the incident description and resolution to a user or other program to address the possibly occurring incident. The analyzer 213 can also communicate the metric subset associated with the random decision forest that communicated a notification to the analyzer 213. A notification may only indicate a metric subset, in which case the analyzer 213 can provide identifiers of the metric subset for root cause analysis or perform root cause analysis to some extent based on the metrics in the metric subset.

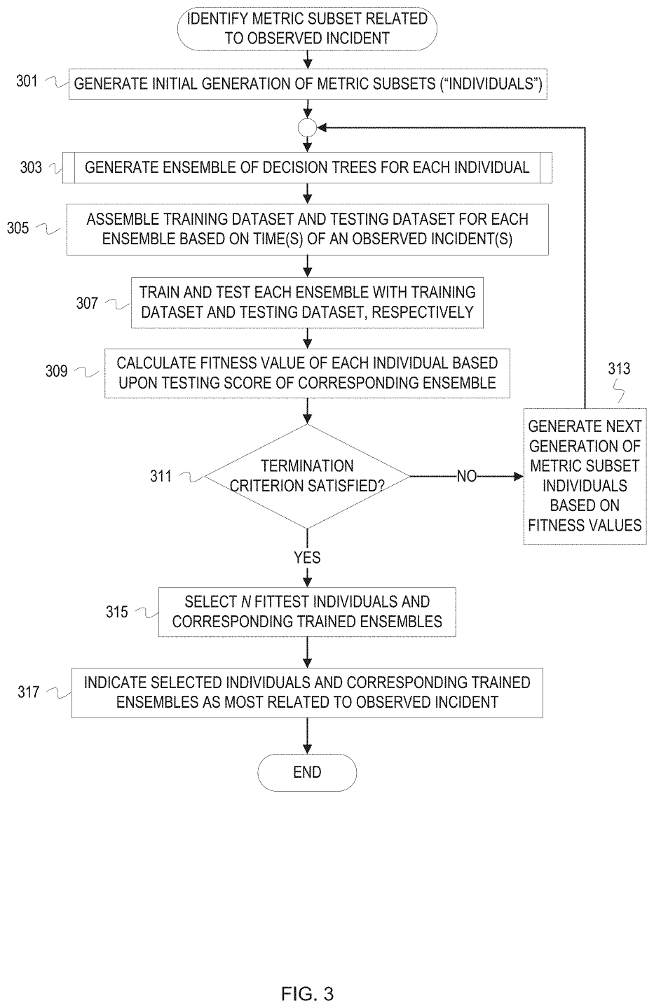

FIG. 3 is a flowchart of example operations for identifying a metric subset related to an observed incident. The FIG. 3 description refers to an optimization search engine as performing the example operations for consistency with FIG. 1. A program that implements this “optimization search engine” likely invokes calls to subroutines or other code units that implement a genetic algorithm and random decision forest. These subroutines or code units will not have the program code that coordinates training and testing data retrieval based on GA individuals and coordinates the forest scoring and individual evolution.

An optimization search engine generates an initial generation of individuals that each indicate a subset of metrics (301). The population size will depend upon specified parameters for the GA. The individual size may be specified by a parameter that is used to generate the data structures that will be individuals once populated or a defined data structure can be used. The optimization search engine can use a quasi-random number generator to randomly select metrics to create individuals. The selection is from a candidate pool of metrics. This candidate pool may be specified external to the optimization search engine. For instance, the universe of metrics being monitored for a distributed application can be filtered down to hundreds of metrics based on the observed incident. In some embodiments, the pool of candidate metrics can be all of the metrics being monitored. Regardless of the specific manner in which the candidate pool is established, the GA selects from the pool to create the individuals based on the individual size parameter. The individuals can be a bit array in which each position or element corresponds to a monitored metric. Mapping data can be maintained that resolves the element or position to the monitored metric represented by that element/position in the bit array. A large candidate pool can result in an unwieldy, or at least inefficient, bit array. Instead, a structure sized to the individual size parameter can be used that has elements sufficient to accommodate a metric identifier. If the individual size is 20 and an integer can identify a metric, then a data structure for the individual would have 20 elements that each can accommodate a 4-byte integer. Mapping data may still be maintained to associate the integer based metric identifier to a string identifier (e.g., pathname), for example.

After generating the generation, the optimization search engine generates an ensemble of decision trees (random decision forest) for each individual in the generation (303). A parameter will have been specified for a number of decision trees in an ensemble. The optimization search engine will invoke a subroutine or module to construct the ensemble for each individual based on the metric subset of the individual.

The optimization search engine assembles a training dataset and a testing dataset for each ensemble based on time(s) of the observed incident(s) (305). The observed incident may have occurred once or multiple times within a source dataset. If identifying a metric subset for a class of incident, then multiple incidents can have occurred that fall within the incident class. The assembled datasets will include an occurrence of the observed incident and samples in which no incident occurred, or at least the observed incident occurred. The samples may include metric values at times which a different incident occurred.

The optimization search engine then trains and tests each ensemble of decision trees with the assembled datasets (307). The optimization search engine trains an ensemble of decision trees with the training dataset assembled based on the metric subset that was the basis for the construction of the ensemble of decision trees. After training on the training dataset, the optimization search engine tests an ensemble of decision trees with the assembled testing dataset.

The optimization search engine uses the scores from testing the ensembles to calculate fitness values of the individuals of the current generation (309). In some embodiments, the forest scores are the fitness values. The optimization search engine can use the accuracy score of the ensemble of decision trees as the fitness value for the corresponding metric subset or individual. The accuracy score can be a straight forward calculated accuracy from the testing that is based solely on correct and incorrection classifications by the ensemble. The accuracy score can instead be calculated as the harmonic mean of precision and recall rate. Embodiments may bias the scoring towards precision or recall based on the potential impact of an incident.

After evaluating a generation (possibly after a warm up number of generations), the optimization search engine determines whether a termination criterion is satisfied (311). Examples of a termination criterion include a number of generations to run, an average fitness across a generation, number of individuals in a generation that exceed a fitness threshold, and variation in fitness values across a generation. Of course, more than one termination criterion can be set. For instance, evolving may terminate after a specified number of generations have had an average fitness value above a specified fitness value. If the termination criterion has not been satisfied, then evolution continues (313).

The optimization search engine continues evolution by generating a next generation of metric subsets or individuals based on the fitness values of the current generation (313). To generate the next generation, the optimization search engine applies a genetic operator(s) to selected individuals of the current generation. Examples of selection schemes to select individuals include proportionate reduction selection schemes, ranking selection schemes, and tournament selection schemes. Examples of genetic operations include crossover and mutation. A GA instance can be programmed to discard individuals in a generation with fitness values that fall below a defined floor and replace those individuals with randomly generated individuals. After generating the next generation, the optimization search engine proceeds to generate ensembles of decision trees (303).

If the termination criterion is satisfied, then the optimization search engine selects the N fittest individuals and the corresponding trained ensembles of decision trees (315). The optimization search engine can maintain references or mappings between metric subsets and ensembles of decision trees. The optimization search engine then indicates the selected individual(s) metric subset and corresponding trained ensemble(s) of decision trees as most related to the observed incident (317). This indicating can be storing the individual(s) and ensemble(s) with an indication of the observed incident, generating a notification with a reference to the individual(s) and ensemble(s) and with an identifier of the observed incident, etc.

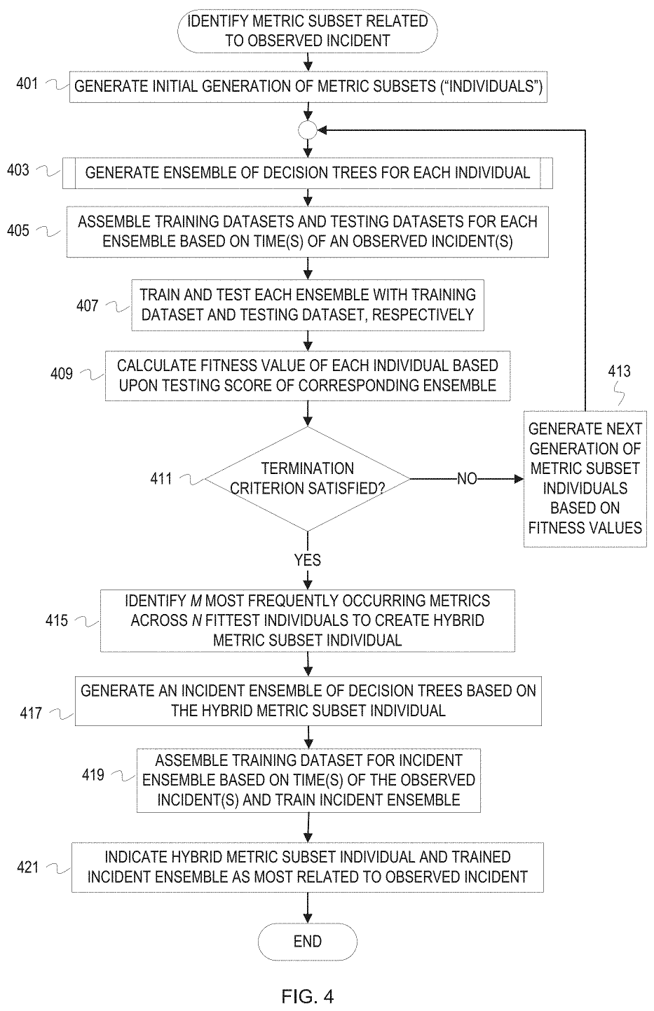

Although the example operations of FIG. 3 selected the fittest individual(s) and corresponding ensemble(s) of decision trees, embodiments can perform further operations to identify a most related set of metrics. FIG. 4 is another flowchart of example operations for identifying a metric subset related to an observed incident. However, FIG. 4 uses the resulting fittest individuals to generate another individual metric subset most related to the observed incident. The example operations in FIG. 4 are the same as those in FIG. 3 until after the termination criterion has been satisfied (415).

An optimization search engine generates an initial generation of individuals that each indicate a subset of metrics (401). After generating the generation, the optimization search engine generates an ensemble of decision trees (random decision forest) for each individual in the generation (403). The optimization search engine assembles a training dataset and a testing dataset for each ensemble based on time(s) of the observed incident(s) (405). The optimization search engine then trains and tests each ensemble of decision trees with the assembled datasets (407). The optimization search engine uses the scores from testing the ensembles to calculate fitness values of the individuals of the current generation (409). The optimization search engine determines whether a termination criterion is satisfied (411). If the termination criterion has not been satisfied, then the optimization search engine continues evolution by generating a next generation of metric subset individuals based on the fitness values of the current generation (413). After generating the next generation, the optimization search engine proceeds to generate ensembles of decision trees (403).

If the termination criterion is satisfied, then the optimization search engine identifies the M most frequently occurring metrics across the N fittest individuals to create a hybrid metric subset individual (415). The optimization search engine can rank the individuals by fitness values and then choose calculate frequency of metrics across the N fittest individuals. The optimization search engine then creates an individual (“hybrid metric subset”) with the M metrics that most frequently occur in those N fittest individuals. M is not necessarily the same as the individual size parameter.

The optimization search engine then generates an ensemble of decision trees based on the hybrid metric subset (417). Since this ensemble will be deployed to evaluate live metric values, it is referred to for this FIG. 4 description as the incident ensemble of decision trees. The optimization search engine also assembles a training dataset based on the time(s) of the observed incident(s) (419). The training dataset is be used to train the incident ensemble of decision trees.

After training the incident ensemble of decision trees, the optimization search engine indicates the hybrid metric subset individual and trained incident ensemble of decision trees as most related to the observed incident (421). In addition to the training dataset, the optimization search engine may also assemble a testing dataset to test the trained incident ensemble decision tree. The scoring from the testing can be indicated in metadata associated with the incident ensemble of decision trees and/or used to generate a confusion matrix to describe the incident ensemble of decision trees.

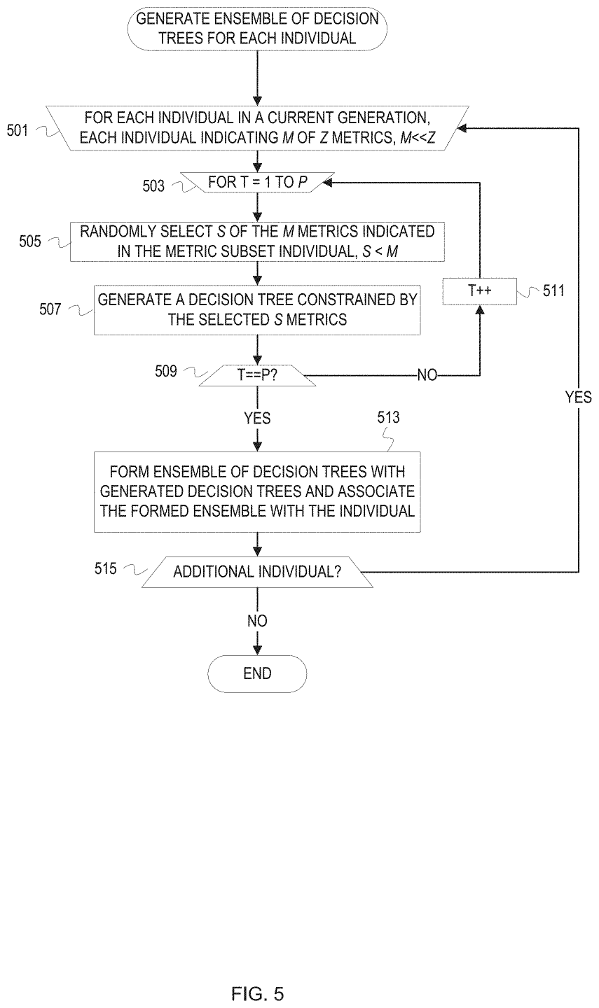

FIG. 5 is a flowchart of example operations for generating an ensemble of decision trees for each metric subset individual. Although available program code for a random decision forest is likely invoked for some of these example operations, the description refers to an optimization search engine as performing the example operations since many of the example operations would not be performed by invoking available program code.

The optimization search engine iterates over each individual in a current generation to generate an ensemble of decision trees for each individual (501). The optimization search engine has already created each individual to indicate M of Z metrics, with M being substantially less than Z assuming Z is all of the metrics being monitored for a system. Assuming a forest size parameter P, the optimization search engine repeats tree constructions for T=1 to P iterations (503).

For each decision tree construction, the optimization search engine (quasi) randomly selects S of the of the M metrics indicated by the metric subset individual (505). S is a configuration parameter set for the program code that constructs each decision tree. Construction of a decision tree is based on specifying a number of attributes to be evaluated by the decision tree. S will be less than M and may depend upon the P parameter. In this case, the attributes are the metrics indicated in the metric subset individual. The optimization search engine generates a decision tree constrained by the selected S metrics (507). The optimization search engine can employ an information entropy and gain technique to analyze the types of information expressed by the metrics based on the measuring component (e.g., bytes per second) and potential values. The optimization search engine may maintain a metadata file or database that identifies each metric and includes a descriptor(s) that describes the measuring component and possible values. The optimization search engine repeats this selection of metrics and decision tree constructions until P decision trees have been constructed (509), using the loop control variable T (511).

After generating the P decision trees for the current individual in the current generation, the optimization search engine forms an ensemble of decision tree with the P decision trees (513). The optimization search engine can invoke program code that forms the ensemble by generating or selecting program code that accepts the output of the P decision trees and computes a single output for the ensemble based on those P outputs. This may be computed based on majority vote. The optimization search engine continues to the next individual until completing forest construction for the generation (515).

Variations

The example illustrations describe generating and deploying a trained random decision forest or ensemble of tree-based classifiers after termination of a GA run. Embodiments can instead select a decision tree from a final trained ensemble of decision trees. Accuracy scores can be computed for each decision tree of the trained ensemble based on the n fittest individuals in a last generation. The decision tree with the highest accuracy score can then be selected and deployed for classifying live metric data. Embodiments can also select and deploy multiple of the decision trees with the highest accuracy scores from the ensemble.

The example illustrations refer to random decision forests and ensembles of decision trees. Embodiments can employ ensembles of other types of tree-based classifiers. For example, embodiments can use gradient boosted trees.

The examples often refer to an “optimization search engine.” The optimization search engine is a construct used to refer to implementation of functionality for identifying a subset of metrics monitored for a system (e.g., distributed application) as relevant for root cause analysis and/or classification/prediction. This construct is utilized since numerous implementations are possible. An optimization search engine may be an application program, a subroutine of a program, implemented as a library or library file, etc. The term is used to efficiently explain content of the disclosure. The optimization search engine can be referred to with any number of names. Implementations will vary by programming language(s) chosen, platform, developer choices, etc.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the examples operations depicted in FIGS. 3 and 4 for assembling datasets and generating the random decision forests can be done in parallel or asynchronously. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a standalone machine, may execute in a distributed manner across multiple machines, and may execute on one machine while providing results and or accepting input on another machine.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

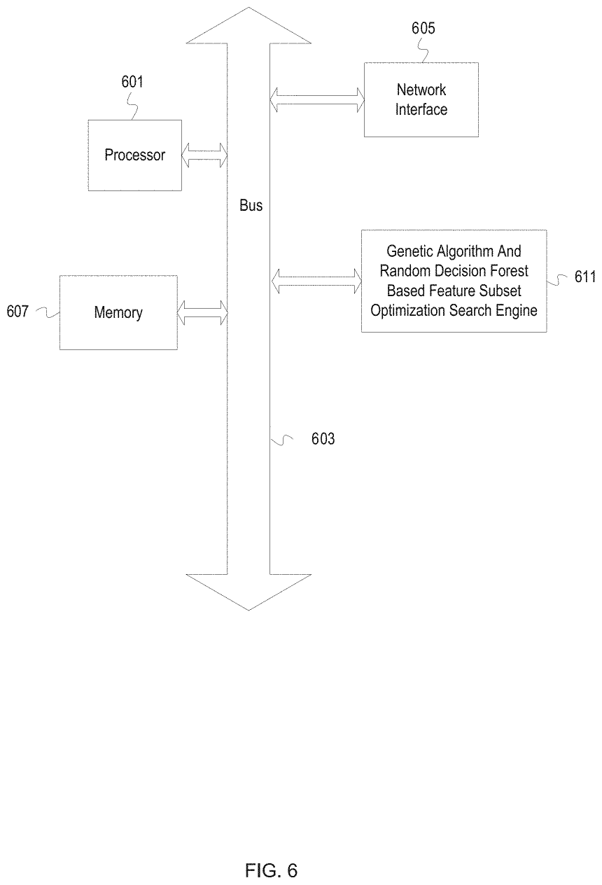

FIG. 6 depicts an example computer system with a genetic algorithm and random decision forest based feature subset optimization search engine. The computer system includes a processor 601 (possibly including multiple processors, multiple cores, multiple nodes, and/or implementing multi-threading, etc.). The computer system includes memory 607. The memory 607 may be system memory or any one or more of the above already described possible realizations of machine-readable media. The computer system also includes a bus 603 and a network interface 605 (e.g., an interface for accepting a wired endpoint or wireless interface). The system also includes genetic algorithm and random decision forest based feature subset optimization search engine 611. The genetic algorithm and random decision forest based feature subset optimization search engine 611 uses a genetic algorithm instance to generate individuals that represent subsets of monitored metrics. The genetic algorithm and random decision forest based feature subset optimization search engine evolves these individuals with fitness values that are based on accuracy scores of trained random decision forests generated based on the individuals of a generation. Any one of the previously described functionalities may be partially (or entirely) implemented in hardware and/or on the processor 601. For example, the functionality may be implemented with an application specific integrated circuit, in logic implemented in the processor 601, in a co-processor on a peripheral device or card, etc. Further, realizations may include fewer or additional components not illustrated in FIG. 6 (e.g., video cards, audio cards, additional network interfaces, peripheral devices, etc.). The processor 601 and the network interface 605 are coupled to the bus 603. Although illustrated as being coupled to the bus 603, the memory 607 may be coupled to the processor 601.

While the aspects of the disclosure are described with reference to various implementations and exploitations, it will be understood that these aspects are illustrative and that the scope of the claims is not limited to them. In general, techniques for dimensional reduction for incident related feature subset identification and classifier generation as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
searching with a genetic algorithm a solution space for a set one or more individuals most relevant to a previously observed incident, wherein the solution space is defined by monitored metrics of an application, wherein an individual comprises a bit array with elements of the bit array corresponding to different ones of the monitored metrics;
for each individual in each iteration of the searching,
training and testing a random decision forest with a training dataset and a testing dataset from a first time-series dataset, wherein the training and testing datasets comprise samples from the first time-series dataset that correspond to those of the monitored metrics indicated in the individual and a first of multiple types of observed incidents;
determining a fitness value for the individual based, at least in part, on the testing of the random decision forest; and
after satisfying a termination criterion of the genetic algorithm, identifying a feature subset as most relevant to the first type of observed incident based on at least a fittest individual and a first set of one or more decision trees corresponding to the fittest individual as a classifier for the first type of observed incident.

2. The method of claim 1, wherein determining the fitness value for the individual based, at least in part, on the testing of the random decision forest of the individual comprises determining the fitness value based, at least in part, on accuracy of the random decision forest.

3. The method of claim 2, wherein the accuracy of the random decision forest is a harmonic average of precision and recall computed from testing the random decision forest.

4. The method of claim 1, wherein identifying the feature subset as most relevant to the first type of observed incident comprises identifying the feature subset as the monitored metrics indicated in the fittest individual in a last generation.

5. The method of claim 1, wherein identifying the feature subset as most relevant to the first type of observed incident comprises:
determining the n most frequently occurring monitored metrics across the m fittest individuals in a last generation;
identifying as the feature subset the determined n most frequently occurring monitored metrics; and
training a second set of decision trees with the n most frequently occurring monitored metrics, wherein the first set of one or more decision trees is the second set of decision trees or a subset of the second set of decision trees.

6. The method of claim 1, further comprising testing the first set of one or more decision trees identified after the termination criterion of the genetic algorithm was satisfied and generating a confusion matrix based on the testing of the trained first set of decision trees.

7. The method of claim 1 further comprising, for each individual in each iteration, generating a random decision forest based on the monitored metrics indicated in the individual.

8. The method of claim 1 further comprising, for each individual, obtaining, from a first time-series dataset, values of those of the monitored metrics indicated in the individual, wherein the values are from times corresponding to the first type of previously observed incidents and from times when no incident was observed.

9. The method of claim 1, wherein each bit array has bits set for fewer than all of the elements.

10. The method of claim 1 further comprising:
inputting live metric values of the feature subset into the trained random decision forest; and
based on the trained random decision forest classifying a set of the live metric values as related to the first type of incident, generating an indication that the first type of observed incident has occurred or might be occurring in association with an indication of the monitored metrics in the feature subset.

11. The method of claim 10 further comprising retrieving a resolution for the first type of observed incident and associating the resolution with the indication that the first type of observed incident has occurred or might be occurring.

12. A non-transitory, computer-readable medium having instructions stored thereon that are executable by a computing device to perform operations comprising:
training and testing an ensemble of decision trees for each individual across generations generated from executing a genetic algorithm program,
wherein an individual is a subset of metrics monitored for a system and a generation of the individuals is non-homogenous,
evaluating fitness of the individuals based, at least in part, on testing of trained ensembles of decision trees against first samples of a time-series dataset corresponding to the subsets of metrics of the individuals,
wherein the first samples correspond to times or time boundaries related to observation of a first incident; and
indicating a subset of metrics of a first individual generated after termination of the genetic algorithm program as related to the first incident.

13. The non-transitory, computer-readable medium of claim 12, wherein the operations further comprise generating an ensemble of decision trees for each individual with the ensemble of decision trees constrained to the subset of metrics indicated in the individual.

14. The non-transitory, computer-readable medium of claim 12, wherein evaluating fitness of the individuals based, at least in part, on testing of trained ensembles of decision trees against the first samples comprises determining fitness values for the individuals based, at least in part, on accuracy of the ensembles of decision trees determined from the testing.

15. The non-transitory, computer-readable medium of claim 14, wherein the accuracy of a trained ensemble is a harmonic average of precision and recall computed from testing the trained ensemble of decision trees.

16. The non-transitory, computer-readable medium of claim 12, wherein the operation of indicating a subset of metrics of a first individual generated after termination of the genetic algorithm program as related to the first incident comprises selecting the first individual based on the first individual having the highest fitness value in the last generation.

17. The non-transitory, computer-readable medium of claim 12, wherein the operation of indicating a subset of metrics of the first individual generated after termination of the genetic algorithm program as related to the first incident comprises:
determining the n most frequently occurring metrics across the m fittest individuals in the last generation;
generating the first individual from the determined n most frequently occurring metrics; and
training a set of one or more decision trees with the first individual to generate a trained set of one or more decision trees for classifying live metric values as related to the first incident or not related to the first incident.

18. An apparatus comprising:
a processor; and
a machine-readable medium having program code executable by the processor to cause the apparatus to,
generate, according to a genetic algorithm, an initial generation of feature vectors from a plurality of metrics monitored for a system or application, wherein each feature vector indicates less than all of the plurality of metrics;
construct an ensemble of tree-based classifiers for each feature vector of the initial generation;
for each feature vector in each generation,
train the ensemble of tree-based classifiers corresponding to the feature vector with first samples from a time-series dataset;
test the trained ensemble of tree-based classifiers with second samples from the time-series dataset, wherein the samples correspond to the metrics indicated in the feature vector and some of the samples correspond to an observed incident and wherein the first and second samples are from different times; and
indicate a trained set of one or more tree-based classifiers corresponding to a fittest feature vector for classifying related to the observed incident.

19. The apparatus of claim 18, wherein the machine-readable medium further has program code executable by the processor to cause the apparatus to:
input live metric values of the metrics indicated in the fittest feature vector into the trained set of one or more tree-based classifiers; and
based on the trained set of one or more tree-based classifiers classifying a set of the live metric values as related to the observed incident, generate an indication that the observed incident has occurred or might be occurring in association with an indication of the metrics indicated in the fittest feature vector.

20. The apparatus of claim 18, wherein the machine-readable medium further has program code executable by the processor to cause the apparatus to select the set of one or more tree-based classifiers.
